(19) United States
(12) Patent Application Publication
(10) Pub. No.: US 2006/0179055 A1
(43) Pub. Date: Aug. 10, 2006

(54) Wine categorization system and method

(76) Inventors: Jim Grinsfelder, St. Paul, MN (US); Paul Leska JR., Inver Grove Heights, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/325,158

(22) Filed: Jan. 4, 2006

Related U.S. Application Data
(60) Provisional application No. 60/641,573, filed on Jan. 5, 2005.

(51) Int. Cl. G06F 17/30

(52) U.S. Cl. 707/6

(57) ABSTRACT

A system and device is presented for wine categorization in a database that links vintages into a wine model, and nodes in the wine model into wine categories. Further links relate foods to nodes in the wine categories, thereby allowing user queries relating to foods to retrieve wine vintages that experts consider appropriate for that food.

### PRIORITY

This application claims the benefit of U.S. Provisional Application Ser. No. 60/641,573, filed on Jan. 5, 2005.

### FIELD OF THE INVENTION

The present invention relates generally to database construction. More particularly, it relates to a unique model and construction of a database for categorization of wines.

### BACKGROUND OF THE INVENTION

Numerous retailers have introduced information kiosks into the store environment. In many cases, these kiosks contain product information that is searchable by the user. This allows a user to search for all products available at that retailer that meet criteria that they can establish. Unfortunately, it can be difficult to set up the underlying database that is used by the kiosk for customer inquiries. Traditional databases did not represent the commonalities between different wines while also distinguishing between the characteristics that change in wines from vintage to vintage. In addition, it was difficult to add new wines and vintages to the database without manually entering all information that might be relevant to that wine. What is needed is an improved database model and construct that allows easy updating while not diminishing the user's ability to make complex queries.

### SUMMARY OF THE INVENTION

To meet this need, a system and method is provided to organize a wine categorization system in a database. The system also allows easy additions to the database while taking full advantage of the relationships already established for similar records

### BRIEF DESCRIPTION OF THE DRAWINGS

FIG. 1 is a schematic drawing showing nodes in a hierarchy for a model.

FIG. 2 is a schematic drawing showing a describer linking nodes linking between separate models.

FIG. 3 is a schematic drawing showing the level structure and describers of a wine categorization database system of the present invention.

FIG. 4 is a schematic drawing showing the wine categorization database system of FIG. 3 with sample data.

FIG. 5 is a schematic drawing showing elements in the exploded view used in describer pruning.

FIG. 6 is a flow chart showing a process for describer pruning.

FIG. 7 is a flow chart showing an algorithm for automated wine categorization by region and varietal.

FIG. 8 is a schematic drawing showing the physical model of the wine categorization database system of FIG. 3.

FIG. 9 is a schematic drawing showing an embodiment of the wine categorization database system with rating and qualities models added.

FIG. 10 is a schematic drawing showing an embodiment of the system in which the wine model includes a vintage level.

FIG. 11 is a schematic drawing showing an embodiment of the system in which a Food Matcher establishes a link describing vintages in the Wine Model by Wine Category, and Foods are described by links to Wine Category.

FIG. 12 illustrates the concept of how the Food Matcher associates vintages with foods.

FIG. 13 is a drawing showing an embodiment of the system in which compatibility between vintages and foods is determined by a Food Matcher.

### DETAILED DESCRIPTION OF THE INVENTION

Overview of the System

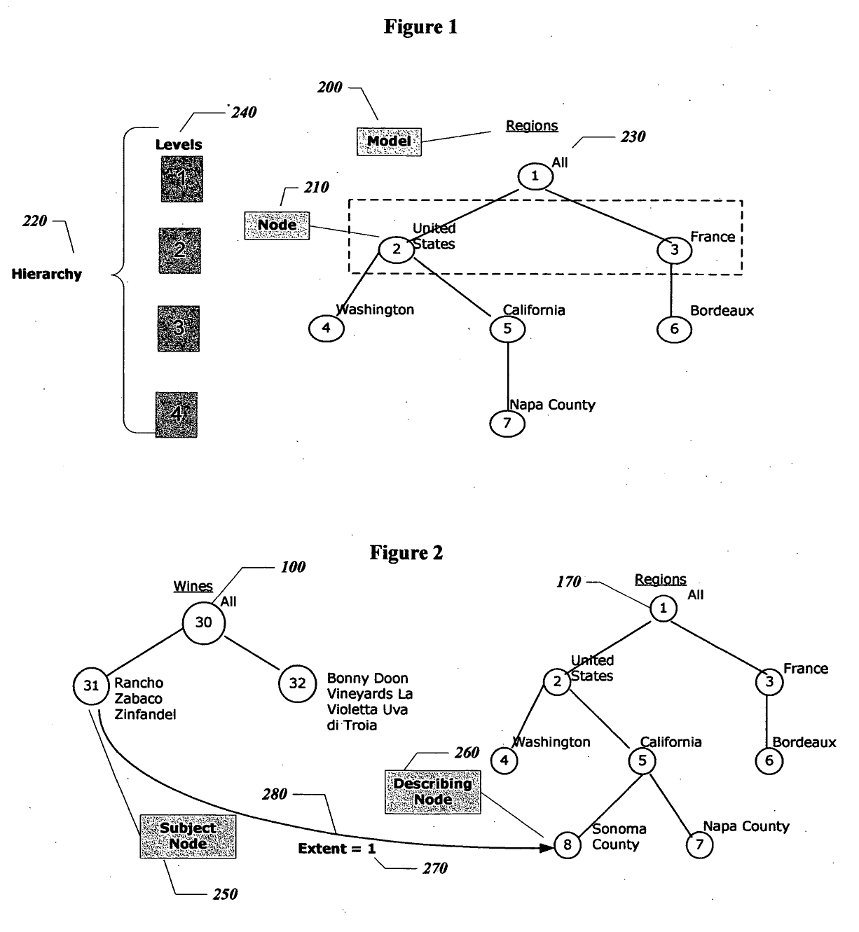

The present invention wine categorization structure is implemented using a plurality of tree models 200 consisting of nodes 210 put together into a variety of hierarchies 220, as shown in FIG. 1. The models 200 and the other elements of the present invention are implemented as software and data structures on standard computing systems, such as those operating Microsoft Windows, Apple Mac-OS, or Unix-based operating systems. In the preferred embodiment, the standard computer system operates as a kiosk in a retail wine/liquor store, allowing a customer to access the present invention database to obtain a wine recommendation.

The models 200 may also be supplemented by one or more data tables. Each model 200 is a data driven collection of organized data elements for the purpose of classification of data and their relationships to other data. The nodes 210 are data element on the computer system that contain (at minimum) a globally unique identifier and a name. Every node 210 belongs to one and only one model 200. The hierarchy 220 is defined as a model 200 with parent-child relationships between nodes 210.

Every hierarchy 220 has a single root node 230, which is the node 210 of a model 200 that represents all elements from the model 200. The root node 230 never has a parent. Every node has a node level 240, which is the depth in the hierarchy starting with the root node 230 (level 1) and following parent/child relationships. In the example shown in FIG. 1, node number 5 (California) has a node level of 3 as it has a parent node 2 (United States) and a grandparent node 1 (the root node labeled “All”). It also has a child node number 7 (Napa County), which has node level of 4. Generally, there are two types of models 200 used in the present invention: a flat model 200 where the highest node level 240 is two, and a hierarchical model 200 where the highest node level 240 is greater than two. A flat model 200 is effectively a rectangular database table.

Describer Links

Nodes 210 are related to each other through describers 280 shown as arrow 280 in FIG. 2. Each describer 280 has a subject node 250, a describing node 260, and an optional strength or extent 270. The subject node 250 is a node 210 in a model 200 that is attributed (or further qualified) by a relationship with a node 210 in another model 200. The describing node 260 is a node 210 in a model 200 that qualifies (or describes) the subject node 250. The extent 270 is an optional numeric qualifier that indicates the strength of a describer 280 qualification where 1 is the strongest qualification and higher numbers are lower strength qualifications.

FIG. 2 illustrates how nodes in one model can be used to describe nodes in another. It shows levels 1 (root node 30) and 2 (wine nodes 31 and 32) of a Wine Model 100. One of those wines is the Rancho Zabaco Zinfandel at node 31. This wine is manufactured in Sonoma County, Calif. This location is found in a Region Model 170 at node 8, whose parent is the California node 5 and whose grandparent is the United States node 2. Hence, the describer 280 shown in FIG. 2 links node 31 (the subject node 250) with node 8 (the describing node 260), with an extent 270 value of 1.

Describer links 280 have a direction or sense, indicated in the figures by the direction of the arrow. When a describer link 280 points from one node to another, this indicates that the first node is described (or classified) by the second. In FIG. 2, for example, the wine at node 31 is described by region 8 in the Region Model 170. This is generally true of all wines in the wine model 100, since wines in model 100 are described by regions in the region model 170. As a shorthand, the Region Model 170 is said to describe the Wine Model 100; even more tersely, Region 170 is said to describe Wine 100.

Describer links 280 indicate explicit relations between pairs of nodes in the various models 200 that are directly stored in the database. In addition, describer links 280 also establish implicit relations that derive from the model hierarchies between model nodes. For a particular describer link 280, if a node ny in model Y explicitly describes (i.e., is represented by an actual describer link 280 stored in the database) a second node nx in model X, then all ancestor nodes of ny (i.e., nodes closer to the root) in Y also implicitly describe nx (so no stored links from any ancestor nodes of ny to nx are necessary). For example, as shown in FIG. 2, because Rancho Zabaco Zinfandel (node 30 in the Wine Model 100) is explicitly described (through a describer 280) by Sonoma County (node 8 in the Region Model 170), then it is also implicitly described by California (Region node 5) and the United States (Region node 2).

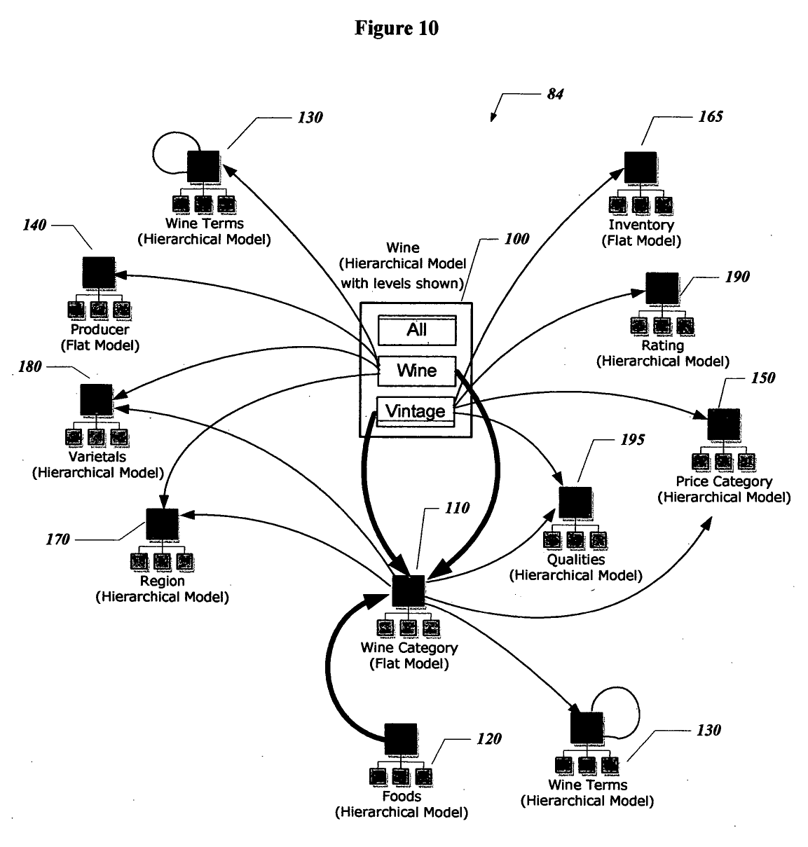

On the other hand, in the same describer link 280 scenario detailed in the previous paragraph, all descendent nodes of nx, if any, are implicitly described by ny (and its ancestor nodes). Suppose that in FIG. 2, node 31 in the Wine Model 100 (Rancho Zabaco Zinfandel) were to have a subnode 33 for the vintage of that wine from the year 2002. (In fact, the embodiments of the invention shown in FIG. 10 through 13 all have a vintage level below the wine level in the Wine Model 100.) Then by virtue of the describer link 280 from node 31 to node 8 in the Region Model (Sonoma County), we know that Sonoma County also implicitly describes 2002 Rancho Zabaco Zinfandel, as do California and United States.

The Wine Categorization System Conceptual Model

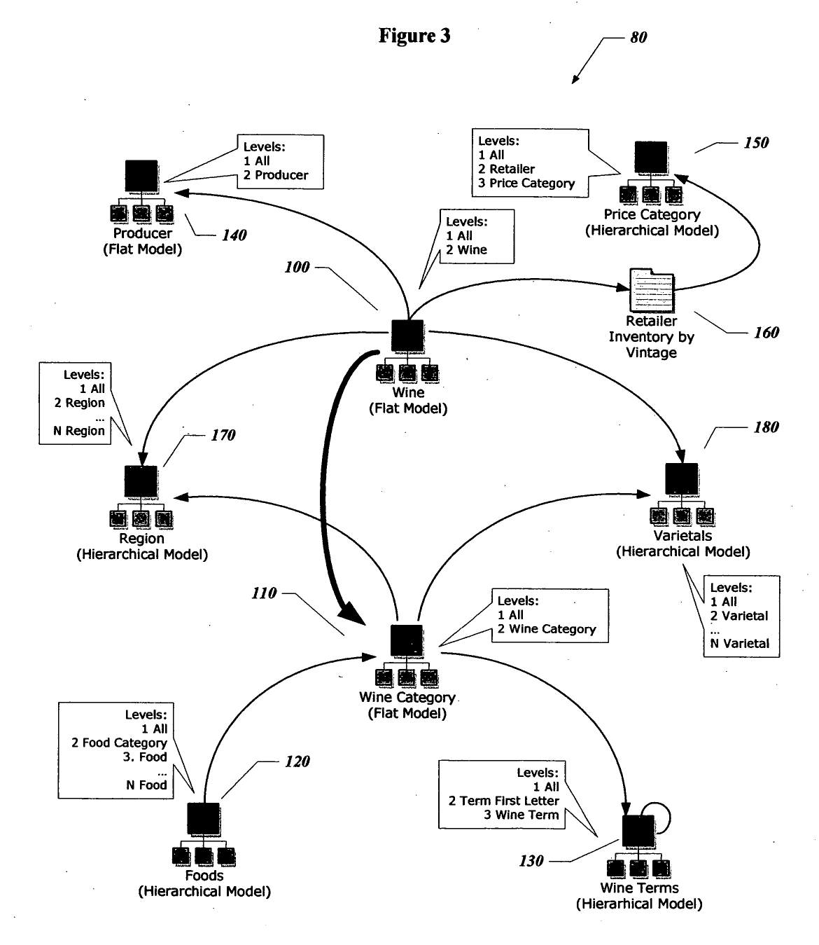

FIG. 3 shows a first embodiment for a conceptual model 80 for the present invention. Different conceptual models are possible, and are described below. All of these conceptual models are built upon a plurality of individual data models, such as the wine model 100 and the region model 170 described briefly above. The data models used in FIG. 3 are as follows:
Wine 100—A model that lists all wines. This is the global wine catalog. Depending upon particular conceptual model for the present invention, the wine model 100 can be flat or hierarchical. In conceptual model 80 shown in FIG. 3, the wine model 100 is flat. When flat, the wine model 100 ignores vintages, and each node outside of the root node contains information about a specific type or brand of wine, such as the Bonny Doon Vineyards La Violette Uva di Trioa shown at node 32 in FIG. 2. A hierarchical wine model 100 would include information about each vintage in a third level of the model hierarchy, as described more fully below.
Wine Category 110—A flat model containing a logical grouping of wines, such as “affordable American zinfandels.” Wine categories allow automatic relationships between wines and foods to be easily created.
Foods 120—A hierarchical model that organizes foods to be paired (i.e., correctly taste matched) with a wine. The model has an appropriate hierarchy for the foods being described (e.g. blue cheese is a type of cheese; chicken is a type of poultry.)
Wine Terms 130—A hierarchical model that organizes definitions of common terms used in the wine industry. The model is hierarchically organized under the first letter of the term. Describers 280 link nodes in the wine category model 110 with the particular definitions in the wine terms model 130 that are relevant for that wine category. Some wine terms are linked to other wine terms within model 130, as shown by the lines in FIG. 3. These simple links indicate only explicit relationships between nodes in the model 130, and do not implicitly infer links or relationships between any other nodes in the wine terms model 130.
Producer 140—A flat model that contains all companies and other entities that produce wine.
Price Category 150—A hierarchical model that lists all retailers using the system and their categories of pricing (e.g. less than $15, $15−30, $30+).
Retailer Inventory by Vintage 160—A flat table (or a flat model) that relates to a wine directly and contains attributes for a vintage. In conceptual model 80, this table 160 contains all of the information for a specific vintage of a wine that would be tracked by a retailer, such as cost, price, barcode, etc.
Region 170—A hierarchical model that lists all regions of the world that produce wine. It has multiple node levels (up to 8 in the preferred embodiment), but is uneven in that some regions are refined where other regions are not. This hierarchy usually tracks one or more national wine region organizational standards (e.g. AVA, AOC, DOCG, DO, etc.).
Varietal 180—A hierarchical model that organizes the type of wine. Some wines, such as reds, whites, and fortified, are refined at further levels (e.g., Zinfandel is a type of Red.)

In addition to the above model, each embodiment must, at a minimum, (1) relate vintage to wines; (2) relate vintages to inventories; and (3) describe compatibilities between wines or vintages and foods. The various embodiments have some differences in how they supply these relationships.

In conceptual model 80 of the preferred embodiment, Wine 100 is described by the Wine Category Model 110, the Region 170, the Producer 140, and the Varietal 180 models. Wine 100 is also related by Wine ID to the Retailer Inventory by Vintage Table 160. The Retailer Inventory by Vintage Table 160, in turn, is related to Price Category 150 by Retailer Id and Price. The Wine Category model 110 is itself described by Region 170, by Varietal 180, and by Wine Term 130. The Foods model 120 is described by the Wine Category Model 110.

The organization of conceptual model 80 allows the rapid assignment of wines 100 into a unique set of categories 110. These categories 110 allow the wine 100 to be automatically paired with a food 120 or associated with educational content 130 (i.e. definitions of common wine terms that are encountered with particular types of wines). This method of wine assignment has several benefits for wine information management. First, wine and food pairings can be done without having to update every vintage of every wine when new foods are paired with categories. By pairing wine educational terms in model 130 with nodes in the Wine Category Model 110 rather than with individual wine vintages or wines, the process of introducing and maintaining such associations is greatly simplified. Furthermore, new vintages of a wine or even new wines can be automatically categorized, and related wines (wines in the same wine category) are easy to identify. Finally, this system provides a fast and convenient method for a customer to search for wines based on many attributes that are related to both the wine and its category at the same time.

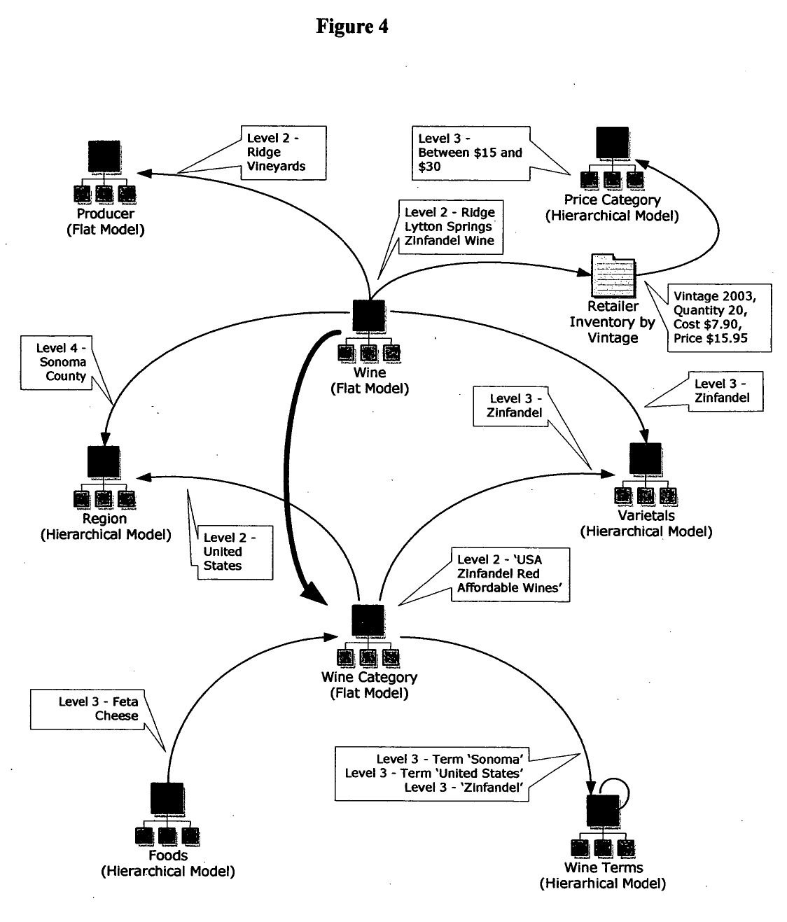

The categorization system in FIG. 3 is also shown in FIG. 4, where example data items have been added for clarification. The example data items illustrate particular values of nodes in the various models 200, and how they might describe each other. FIG. 4 shows the data in the conceptual model 80 for a bottle of 2003 Ridge Lytton Spring Zinfandel wine. When this vintage is added to the system, it is associated by a Wine ID with the Ridge Lytton Springs Zinfandel wine in the Wine Model 100 that is used for all vintages of this wine. Based on this association, we know that this wine vintage can be described as being produced by Ridge Vineyards, as coming from Sonoma County, Calif., and being a Zinfandel. We also know that is can be categorized as a USA Zinfandel Red Affordable Wine in the Wine Category Model 110. Based upon previous expert analysis, we know that wines in this category go well with feta cheese. Hence, by merely linking the vintage to the appropriate wine, the vintage will appear in search results relating to wines that go well with feta cheese.

Describer Pruning to Prevent Empty Searches

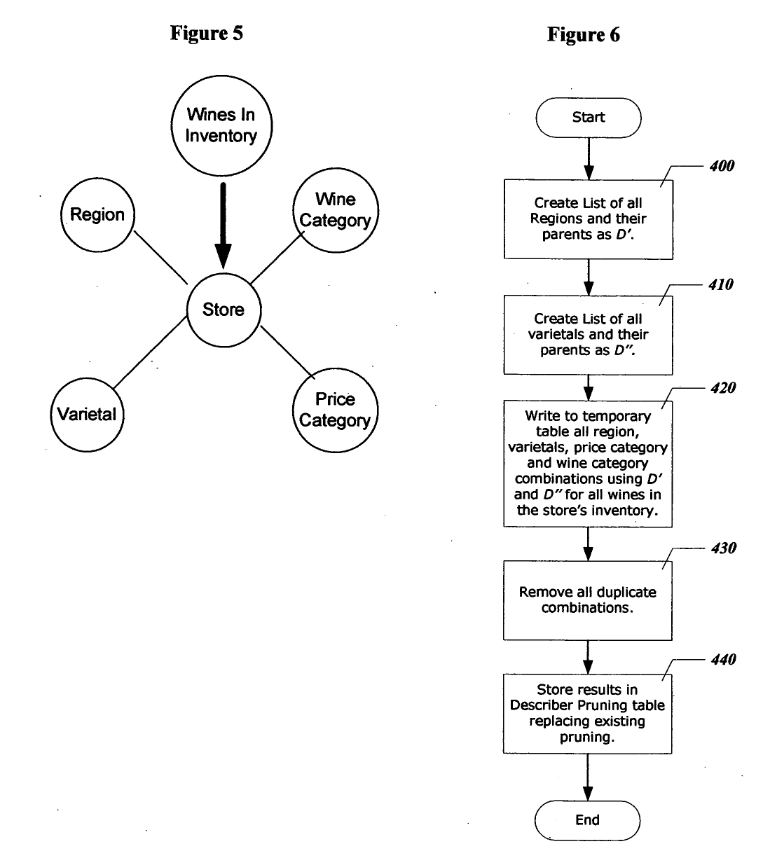

FIG. 5 and FIG. 6 illustrate an algorithm for creating an exploded view of all combinations of nodes from the various models 200 that can describe the vintages of wine in inventory at a particular retailer. This allows the system to prevent the user of a kiosk from entering search criteria that do not return any useful results or return as results wines that are not available at that store. For example, a search for a robust Chianti that goes well with baklava would yield no results and would not be allowed. The system does this by using describers 280 to prune the various models 200 so that they show only the possible nodes and children of nodes based on other selections made in other models 200. The goal is to create a table of all allowable combinations of regions, varietals, price categories and wine categories for a given store for every wine in the current inventory (see FIG. 5). This exploded view must include any description implicit in the use of describers 280 and the node hierarchy. For instance, as discussed in a previous example, a wine described as from the Napa Valley is also from California and the United States, while a zinfandel is also a red wine. The exploded view for a single wine, such as the Ridge Lytton Springs Zinfandel Wine shown in FIG. 4, would therefore lead to multiple entries in the exploded view table, This is seen in the following table:

TABLE 1

| | | | Price |
|---|---|---|---|
| Region | Wine Category | Varietal | Category |
| Sonoma County | USA Zinfandel Affordable | Zinfandel | Level 3 |
| California | USA Zinfandel Affordable | Zinfandel | Level 3 |
| United States | USA Zinfandel Affordable | Zinfandel | Level 3 |
| Sonoma County | USA Zinfandel Affordable | Red | Level 3 |
| California | USA Zinfandel Affordable | Red | Level 3 |
| United States | USA Zinfandel Affordable | Red | Level 3 |

Since all foods are linked to an individual wine or vintage through the wine category, there is no need to include entries on this table for each possible food recommendation. The inclusion of wine category will ensure that all possible food recommendations will be easily discoverable. Of course, a wine may belong to multiple wine categories, which would increase the number of entries for that wine. In addition, if other variables associated with a wine were available for user searches, these variables would be added to this explosion table. Other Sonoma County zinfandels in the same price category would create the same entries in this table. By removing all duplicate table rows, the explosion table would list all possible combinations for the wines in inventory.

As shown in the flow chart of FIG. 6, the system creates an explosion table of this type by first creating at step 400 a list of all regions 170 for wines with positive inventory levels at a retailer. This list includes all parent regions as well. This result set is called D′. The system then creates at step 410 a list of all varietals 180 for wines with positive inventory levels and their parent varietals. This result set is called D″. In step 420, the system combines the Cartesian product of both result sets D′ and D″ along with every combination of price category and wine category to which the wines are related by a describer 280. All duplicate combinations are removed from the combined result set at step 430. This final result set is stored at step 440 in the database to be used for criteria selection pruning in a user interface that uses this Wine Category Model 110.

The purpose of selection pruning is to ensure that the user is never offered a selection choice that well result in an empty set of wines being returned. As an example, a particular retailer might have in stock only four different wines from Sonoma County—two merlots, a zinfandel, and a pinot noir. When the user of the kiosk selects wines from Sonoma County, the selection pruning of the present invention would allow only allowable choices for further searching. For instance, under varietal the user could only select from red, merlot, zinfandel, and pinot noir. There would be no ability to pick “white” or “chardonnay,” since these selections would result in no wines meeting the user's search criteria. Similarly, the kiosk would restrict price category and food matches to those that correspond to the four remaining wines.

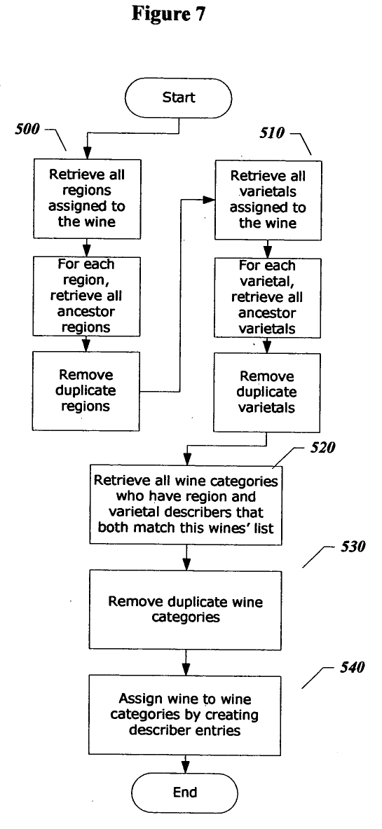

FIG. 7 illustrates an algorithm for automatically assigning wines 100 to wine categories 110 through the use of describer links 280. The algorithm uses the Region 170 and Varietals 180 describers 280 that exist for both the wine 100 and wine category 110 nodes 210. This assumes that wine categories are described exclusively by Region and Varietals. If, however, other models can describe a wine 100 or wine category 110, these other models will be included in the algorithm of FIG. 7. The system retrieves at step 500 the regions (including all ancestors) for this wine. The system then retrieves at step 510 all varietals (including all ancestors) for the wine. At step 520, the system retrieves all wine categories that have describer 280 relationships to any of the region/varietal combinations from the previous two steps. The system removes duplicates wine category assignments in step 530. Finally, the system then creates describer 280 relationships between the wines and the wine categories that had compatible regions and varietals combinations at step 540, thereby completing the assignment.

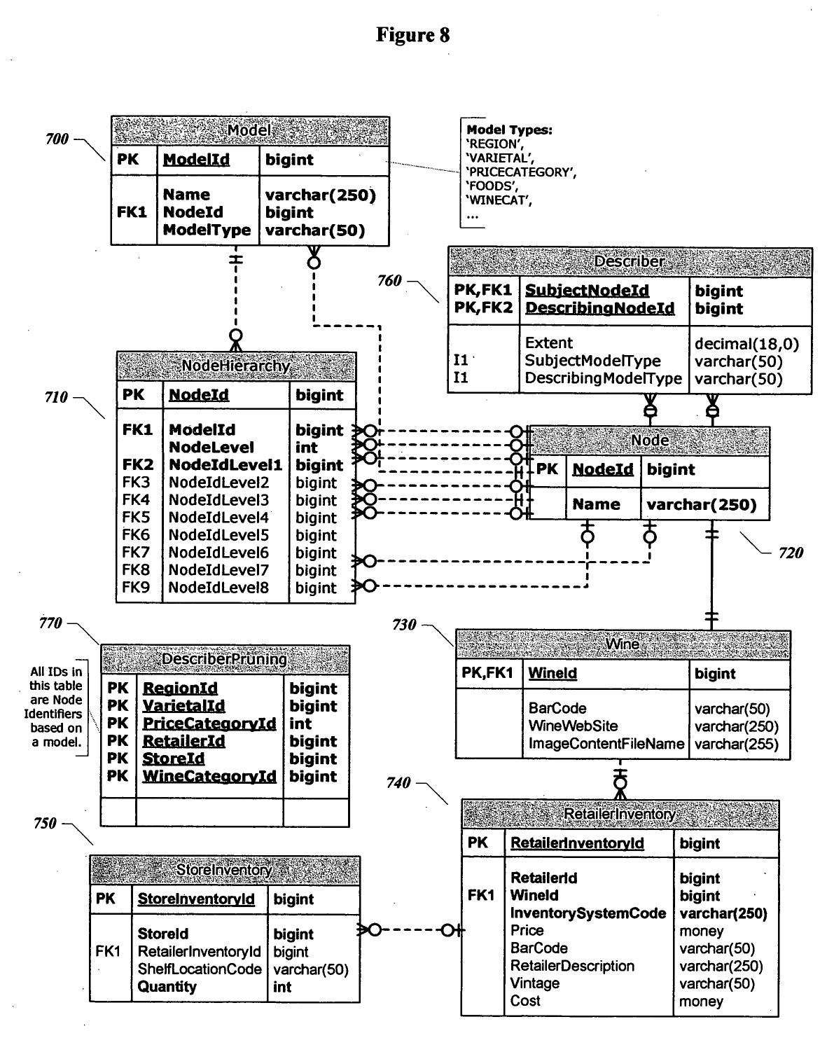

FIG. 8 is a physical entity relationship diagram showing the table structures for storing the wine categorization system. The physical entities and relationships are as follows:
Model 700—Stores all models defined. The Node Id is a link to the Node Hierarchy 710 that is the root node of the model.
Node Hierarchy 710—Store all branches of the hierarchy. The Node Id is a link to the Node Id of the Node 720 table. The Model Id is a link back to the Model 700 table. Each NodeIdLevelX is an optional link to a node at the node level depth of a tree. Every path from the root node to a node in a tree will have a Node Hierarchy 710 record.
Node 720—Stores the globally unique identifier and a name for the elements in the models.
Wine 730—A subclass of the Node 720 table giving additional qualification to nodes that are in the Wine model. Every Wine Id in Wine must be a Node Id in Node from the Wine model.
Retailer Inventory 740 and Store Inventory 750—Tables to give the instance specific details of a vintage of a wine for a retailer. These are details that vary by vintage, retailer and store.
Describer 760—A link between two nodes. The nodes can be in the same model or a different model. This is the key relationship that allows for flexible attribute in the wine categorization system.
Describer Pruning 770—A stored explosion of all searchable attribute combinations for a retailers list of wines in a store. This is produced in the algorithm specified in FIG. 4.

The physical implementation shown in FIG. 8 is the preferred technique for implementing the conceptual model 80 shown in FIG. 3. However, this is not the only possible physical implementation. For instance, it would be well within the scope of the present embodiment to implement the nodes in hierarchical model with a parent and/or child link, or with a single parent identifier within each node, thereby allowing the nodes themselves to define the hierarchy.

Second Conceptual Model

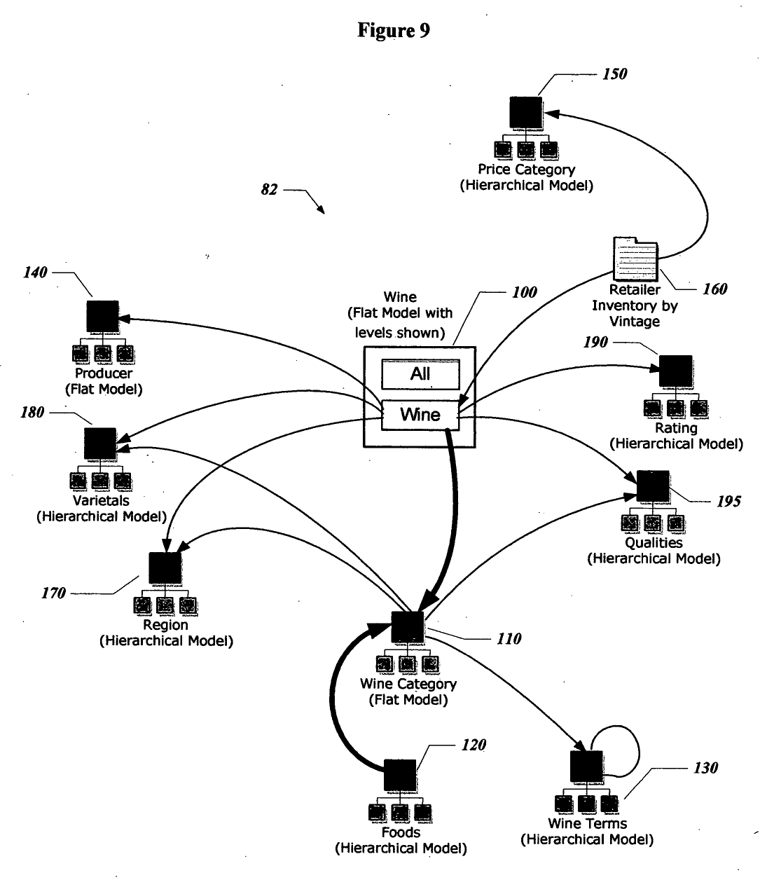

FIG. 9 shows conceptual model 82, which is an alternate embodiment of the present invention. FIG. 9 shows the two levels of the Wine Model 100 for comparison with subsequently described embodiments. Conceptual model 82 adds two new models not found in conceptual model 80, namely the Rating model 190 and Qualities model 195.
Rating 190—A hierarchical model that contains ratings made of the wine by independent wine experts. The Rating Model 190 has two levels below the root: the authority or source of the rating (which might be a magazine or a well-known expert), and a rating score. Regardless of authoritative source, the scores can be converted to a uniform scale (e.g., 0 to 4 stars) to make all ratings comparable. Alternatively, the ratings could be retained in their original format so as to allow end users to directly specify both a rating and an authority.
Qualities 195—A hierarchical model that contains terms that are used to describe wine characteristics, such as “buttery,” “fruity,” or “almonds.” The Qualities model 195 may be flat or have multiple levels depending on the sophistication desired. For example, the node “fruity” might have children nodes “cherry” and “apple.” These terms can be assigned by an expert particularly for the present invention, or can be taken from expert opinions published for general consumption.

Both the Rating model 190 and the Qualities model 195 describe Wine 100, in the sense that describer links 280 point from wine nodes in the Wine Model 100 to rating nodes and qualities nodes. In conceptual model 82, the Wine Category model 110 is also described by the Qualities Model 195. This allows the creation of categories such as California fruity zinfandels. This conceptual model 82 is like the preferred embodiment of FIG. 3 in all other respects, and in particular, employs automatic wine category assignment and describer pruning. The only distinction is the incorporation of the two additional models 190, 195 into these processes.

Third Conceptual Model

FIG. 10 shows a second alternate embodiment as conceptual model 84. In this conceptual model 84, the Retailer Inventory by Vintage Model 160 has been eliminated. To accommodate the vintage information that was in this model 160, the Wine Model 100 is no longer flat, but now has three levels: root (all), wine brand, and vintage. A given wine brand node can have zero or more vintage nodes below it in the hierarchy. Incorporation of vintage into the Wine Model 100 facilitates the separation of attributes that describe wines (and, thus, implicitly vintages) including Producer 140, Varietal 180, and Region 170 from those that can vary depending on the particular vintage of the wine, such as Inventory 165 (first introduced in this embodiment), Price Category 150, Qualities 195, and Rating 190. The Inventory Model 167 is a flat model (i.e., table) having an entry for each vintage ID that contains the retailer ID, the number of sellable units (e.g., bottles) of the vintage in inventory, the price to customers, the cost paid by the retailer, and some record of sales history to allow the system to assess the popularity of the vintage.

As in the two previously described embodiments 80, 82, wines 100 within conceptual model 84 can be linked by descriptors to Wine Category 110 nodes. Wine categories, in turn, describe nodes in the Foods Model 120. Here, as previously, the direction of the describer 280 arrow points from Foods 120 to Wine Category 110, and from Wines 100 to Wine Category 110. This link from a wine node to a food node through Wine Category 110 means that all vintages (children) of that wine are compatible with the food node and any food subnodes (or children). For example, if a wine is linked with poultry through this method, this implies that any vintages of the wine will go well with chicken.

In conceptual model 82 shown in FIG. 9, wines 100 were linked to the qualities model 195. In conceptual model 84, vintages can be directly described by the Qualities model 195. This is done because the wine qualities 195 assigned to a wine might vary from vintage to vintage. For instance, the 2001 vintage of a wine might be considered to have cherry flavors, while the 2002 vintage might not. By separately assigning qualities to a particular vintage, this conceptual model 84 allows individual vintages to be assigned to a wine category 110, as shown in FIG. 10. This can be done automatically using a process similar to that set forth in FIG. 7. However, the process would start with a particular vintage, and first gather all regions (step 510) and all varietals (step 520) assigned to the parent wine node for that vintage. The process would then examine all qualities 195 assigned for the vintage, including the examination of parent qualities and the removal of duplicates. At this point, wine categories 110 would be examined with matching regions, varietals, and qualities (steps 520 and 530), and then create describer links directly from the vintage to the wine category 110. Alternatively, the describer link can be imputed to the parent wine in wine model 100, and with the describer link being made only from the parent wine to the wine category 110. However, this imputing is not preferred, and conceptual model 84 is best thought of as a assigning some describer links directly between a vintage and a wine category 110. The describer pruning process is then slightly varied, in that it is necessary to examine not only the wine categories 100 assigned to a wine for each vintage in inventory, but also the wine categories 110 assigned to the particular vintage itself. In addition, to allow searches directly on the wine qualities, the exploded table of all search options should include the qualities (and their parents) that are assigned to wine vintages in inventory.

Fourth Conceptual Model

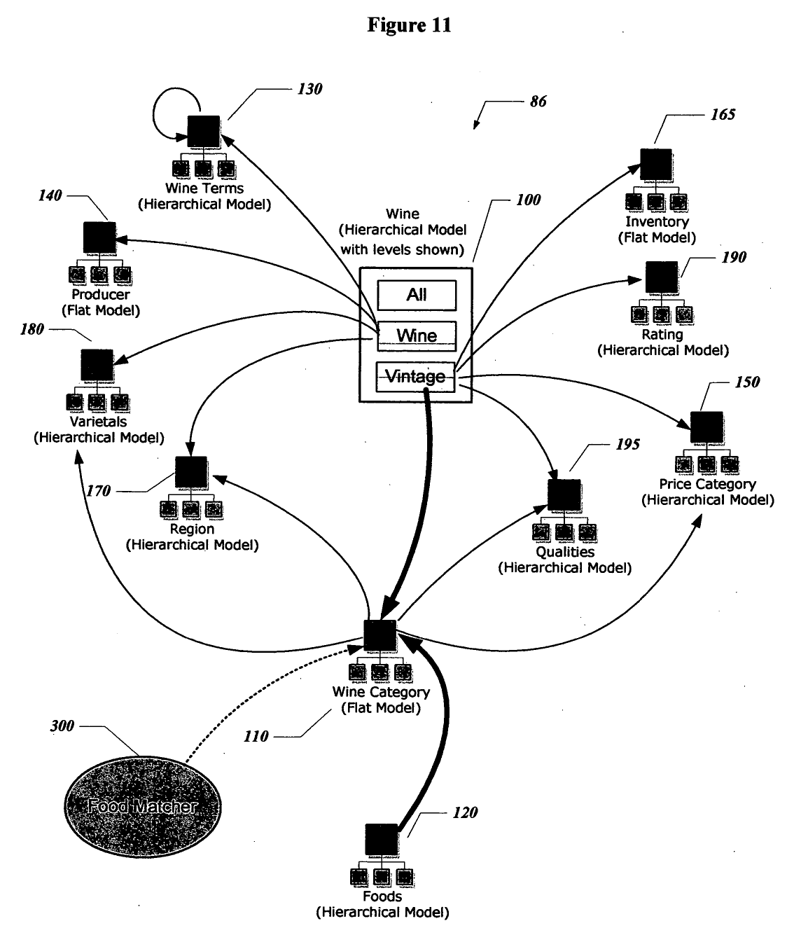

FIG. 11 shows a fourth conceptual model 86 for the present invention. This embodiment differs from the conceptual model 84 in FIG. 10 in two important respects. Here wine vintages alone (rather than wines) in the Wine Model 100 are associated by describer links 280 to the Wine Category Model 110. In addition, the wine categories 110 in this conceptual model 86 are created with the assistance of a food matcher 300.

In the previously described embodiments, expert opinion provides the data upon which the various wine categories 110 were created. If an expert believes that affordable American zinfandels go well with feta cheese, a wine category is created for affordable American zinfandels and a describer link 280 is created to link the category with the Foods model 120. Wines and vintages in the Wine model 100 that meet the requirements for the new wine category are then linked automatically to the Wine Category 110, and the match to the Foods model 120 is complete. The fourth conceptual model 86 differs in that the Food Matcher 300 is used to create each Wine Category 110.

The Food Matcher 300 is based on statistical learning from data. There are a wide variety of techniques from which to choose that are detailed in standard texts as solutions for “supervised learning problems” described as follows:
In a particular implementation of [statistical learning from data], we have an outcome measurement, usually quantitative (like a stock price) or categorical (like heart attack/no heart attack), that we wish to predict based on a set of features (like diet and clinical measurements). We have a training set of data, in which we observe the outcome and feature measurements for a set of objects (such as people). Using this data we build a prediction model, or learner, which will enable us to predict the outcome for new unseen objects. A good learner is one that accurately predicts such an outcome.
   Hastie, T., R. Tibshirani, and J. Friedman, The Elements of Statistical Learning: Data Mining, Inference, and Prediction, Springer-Verlag, N.Y., 2001, pp. 1-2.

In other words, Hastie et al. enumerate the fundamental elements required by most of the supervised learning techniques that are very familiar to practitioners of predictive statistics. In our invention, a supervised learning algorithm is desired to predict matching between a vintage and a node in the Foods Model 120. The features in our case are the attributes that are associated with a wine or vintage, such as Producer 140, Price Category 150, Region 170, Varietal 180, Rating 190, and Qualities 195. The training set is based on opinions of experts on associations of particular wines (and hence wine features) with foods. The opinion can either be binary (i.e., a given wine either does or does not “go” with that food) or a strength or extent 270 score. Each opinion for a wine-food pair produces a data point that will be used as input for construction of an algorithm that will be embodied in software form. A set of wines with a diverse set of features must be included in the training set to produce a good learner. The Food Matcher 300 is the software that results from constructing a supervised learner based on the training set. In effect, the Food Matcher 300 takes a set of wine features and expert scores as its input, and applies a mathematical formula to either get a yes/no answer or a strength score for the association of the wine having those features and the food.

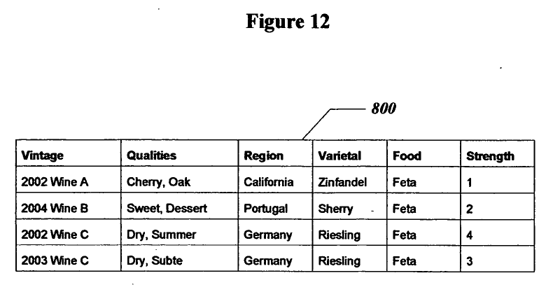

For example, FIG. 12 shows in a table 800 the result of expert analysis for four vintages and their compatility with feta cheese. With enough data points, the Food Matcher 300 can learn that wine vintages with certain qualities go well with feta cheese. From this, the Food Matcher 300 can infer which other vintages with similar attributes will also be a good match for feta. If such a determination is made, the Food Matcher 300 can create an appropriate wine category and associate the wine category with the corresponding qualities and foods. The association of vintages or wines in the wine model 100 with the newly created wine categories can happen automatically as described above, with each assignment being based upon matching attributes associated with the new wine category 110 with the attributes already associated with the wine 100.

Fourth Alternate Embodiment

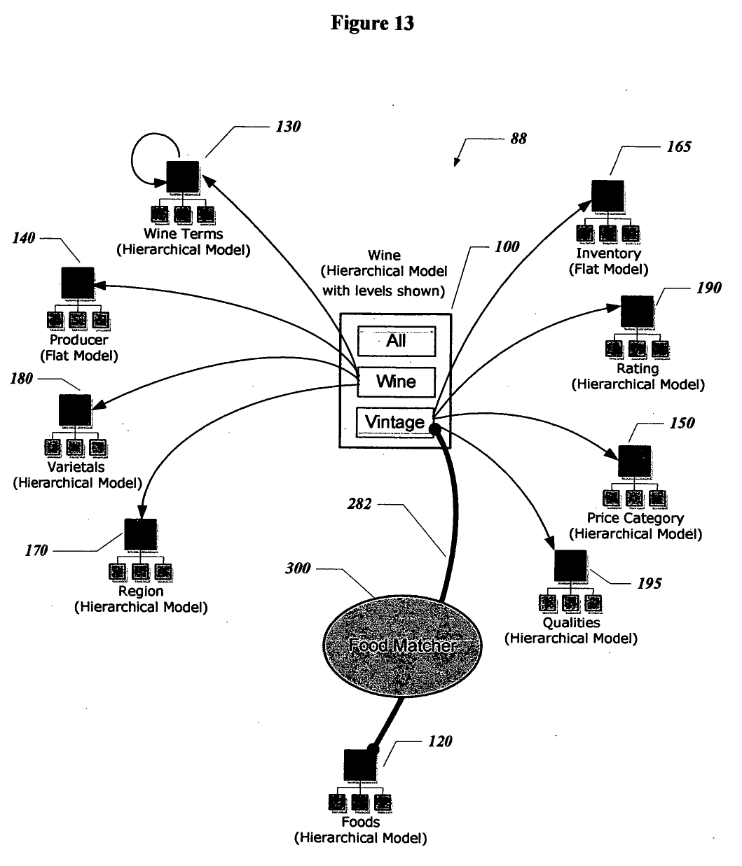

Eliminating the Wine Category Model 110 entirely, the fifth conceptual model 88 takes the Food Matcher 300 concept one step further than the conceptual model 88 of FIG. 11. As shown in FIG. 13, a Food Matcher 300 (i.e., a supervised statistical learner) is used to associate vintages in the Wine Model 100 directly with foods in the Foods Model 120. The approach to creating the supervised learner is the same: for a given food or food group in the Foods Model 120, train the learner with expert opinions about the existence or strength of the compatibility of each vintage in the training set with that food. Then apply the learner to new vintages that are added to the inventory.

While this approach may require more expert opinions and be somewhat more difficult to construct than a Wine Category Model 110 to effect matching of wine vintages to foods, it is also less arbitrary and constraining. No one needs to choose a limited set of categories. Also, inherent in the category model approach is the assumption that all vintages mapped to the same category go with all of the same foods. With the predictive algorithm approach, much more precise and individualized mappings are possible, particularly ones that take advantage of words expressing qualities (e.g., “leathery” or “green”) whose perceived applicability may vary among vintages of the same wine.

This conceptual model 90 uses a new kind of link known as a compatibility link 282. This link 282 is used in addition to the describer links 280 to represent relationships between the models 200 in the database. A compatibility link 282 indicates that the subject matter of two nodes are compatible with each other. A compatibility link 282 is indicated in the drawings by a curved line segment linking two nodes and terminating in filled circles, such as the link connecting wine vintage with Foods 120 in FIG. 13.

The rules implicit relations for compatibility links 282 are somewhat different from the implicit relations described above for describer links 280. Both ends of a compatibility link 282 behave similarly to described node ends (i.e., the end without the arrowhead) of describer links 280. If a node nq in model Q is explicitly compatible with (i.e., represented by an actual compatibility link stored in the database) a second node nr in model R, then all descendent nodes of nq in Q are implicitly compatible with nr and with its all descendent nodes in R. So if a Sweet Red node in a hierarchical version of the Wine Category Model 110 were associated by a compatibility link with a Pungent Cheese node in the Foods Model 120, this implies (without explicit database representation) that a sweet red wine will also go well with parmesan cheese, and, in particular, that parmesan cheese will also goes well with a red concord wine.

The conceptual model 80 in FIG. 13 requires another slight modification to the describer pruning described above. Instead of exploding on wine categories 110 as shown in FIG. 5, conceptual model 90 would be forced to explode on all foods 120 (including subnodes or children) linked to a vintage in inventory. While this would create a larger pruning table that with models that use the wine category model 110, the benefits of directly associating foods 120 with vintages may overcome that inconvenience.

The present invention is not to be limited to all of the above details, as improvements, modifications, and variations may be made without departing from the intent or scope of the invention. For instance, multiple independent schemes for pairing wines and foods can exist simultaneously by simply maintaining several different versions of the Wine Category Model 110. Consequently, the invention should not be limited by the specifics of the above description, but rather be limited only by the following claims and equivalent constructions.

What is claimed is:

1. A database construct stored digitally on a computer system for categorizing wines comprising:
a) a plurality of hierarchical models, each hierarchical model having a single top root node, a plurality of children nodes under the root node, and a plurality of grand children nodes below the children nodes, wherein children are considered parents or ancestors of grand children nodes directly below them in the hierarchy, wherein the hierarchical models include
i) a regional hierarchical model representing regional origins of the wines;
ii) a varietal hierarchical model representing varietals of the wines;
iii) a food hierarchical model representing a plurality of foods;
b) a wine model having nodes with each node representing one wine;
c) a wine category model having nodes representing groupings of wines;
d) a plurality of describer links linking from nodes in the wine model to nodes in the regional and varietal hierarchical models;
e) a logical association between nodes in the wine model and nodes in the wine category model; and
f) a logical association between nodes in the wine category model and nodes in the food hierarchical model.

2. The database construct of claim 1, wherein the describer links are directional logical associations originating from a first node to a second node, the describer links creating explicit relations between the first and second nodes and creating implicit relations between the first node and the ancestors of the second node.

3. The database construct of claim 2, wherein the describer links create implicit relations between the children of the first node and the second node.

4. The database construct of claim 3, wherein the describer links create implicit relations between the children of the first node and the ancestors of the second node.

5. The database construct of claim 4, wherein the wine model is hierarchical with the children of the root node representing wine brands and the grandchildren of the root node representing wine vintages.

6. The database construct of claim 5, wherein the logical association between the nodes in the wine model and the wine category model are describer links from the wine model to the wine category model.

7. The database construct of claim 6, wherein at least some of the describer links from the wine model to the wine category originate at the children of the root node of the wine model.

8. The database construct of claim 6, wherein at least some of the describer links from the wine model to the wine category originate at the grandchildren of the root node of the wine model

9. The database construct of claim 6, wherein the logical association between the nodes in the wine category model and the food model are describer links from the wine category model to the food model, wherein a first describer link from a first node in the wine model to a first node in the wine category model and a second describer link from the first node in the wine category model to a first node in the food model creates:
i) an explicit relation between the first node in the wine model and the first node in the food model,
ii) an implicit relation between first node in the wine model and ancestors of the first node in the food model,
iii) an implicit relation between children of first node in the wine model and the first node in the food model, and
iv) an implicit relation between children of first node in the wine model and the ancestors of first node in the food model.

10. The database construct of claim 2, wherein the logical association between the nodes in the wine category model and the food model are describer links from the wine category model to the food model.

11. The database construct of claim 1, further comprising a plurality of describer links linking from nodes in the wine category model to nodes in the regional and varietal hierarchical models.

12. The database construct of claim 2, further comprising a qualities hierarchical model representing terms used to describe wine characteristics.

13. The database construct of claim 12, further comprising describer links linking from nodes in the wine model to nodes in the qualities hierarchical model, and describer links linking from nodes in the wine category model to nodes in the qualities hierarchical model.

14. A database construct stored digitally on a computer system for categorizing wine vintages, comprising:
a) a plurality of hierarchical models, each hierarchical model having a single top root node, a plurality of children nodes under the root nodes, and a plurality of grand children nodes below the children nodes, wherein children are considered parents or ancestors of grand children nodes directly below them in the hierarchy, the hierarchical models including
i) a wine hierarchical model representing a plurality of wines, comprising children of the root nodes for wine brands and grandchildren of the root node for wine vintages,
ii) a region hierarchical model representing regions of origin,
iii) a varietal hierarchical model representing varietals,
iv) a food hierarchical model representing foods,
v) a wine terms hierarchical model representing words and phrases describing wine qualities,
vi) a price category hierarchical representing groups of prices, and
vii) a ratings hierarchical model representing wine rating authorities and ratings;
b) a plurality of flat models, each flat model having a single layer of data nodes without any children or ancestor nodes that contain data, the flat models including
i) a producer flat model representing producers,
ii) an inventory flat model presenting wine inventory, and
iii) a wine category flat model representing logical groupings of wines;
c) a plurality of describers that are directional logical associations originating from a first node to a second node, the describers creating explicit relations between the first and second nodes and creating implicit relations between the first node and the ancestors of the second node, the describers including
i) describers originating at nodes in the wine model to nodes in each of the region hierarchical model, the varietal hierarchical model, the ratings hierarchical model, the producer flat model, regions of origin model, and the wine category flat model, and
ii) describers originating at nodes in the wine category flat model to nodes in the food hierarchical model; and
d) data elements representing the inventory level and the price of each wine vintage in a retail store.

15. A database construct stored digitally on a computer system for categorizing wines comprising:
a) a wine database model having nodes with each node representing different wines;
b) a regional database model representing regional origins of the wines;
c) a varietal database model representing varietals of the wines;
d) a plurality of describer links linking from nodes in the wine model to elements in the regional and varietal database models;
e) a food database model representing a plurality of foods;
f) a food matcher having
(i) a compatibility dataset consisting of a plurality of entries, each entry having a selected food from the food database model, a selected wine from the wine database model, and an expert compatibility rating; and
(ii) a supervised learner statistical algorithm implemented in computer software creating logical associations between a non-selected wine not in the compatibility dataset and one of the selected food based on the compatibility dataset and commonalities among the describers linking one of the selected wine in the compatibility dataset and describers linking the non-selected wine.

16. A method for associating a wine with a food using a computerized database system comprising:
a) creating within the database system:
FIG. 1.1.1a wine database model having wine nodes representing different wines;
FIG. 1.1.2a first attribute database model having first attribute nodes representing values for a first attribute relating to wines;
FIG. 1.1.3a second attribute database model having second attribute nodes representing values for a second attribute relating to wines;
FIG. 1.1.4a wine category model having wine category nodes representing logical groupings of wines;
FIG. 1.1.5a food database model having nodes with each node representing a different food;
b) creating a plurality of logical links linking:
FIG. 1.1.6 from wine nodes to first and second attribute nodes,
FIG. 1.1.7 from wine category nodes to first and second attribute nodes,
FIG. 1.1.8 from wine category nodes to food nodes,
c) creating a first attribute list of first attribute nodes to which a first selected wine node has been linked;
d) creating a second attribute list of second attribute nodes to which a first selected wine node has been linked;
e) creating a wine category list of all wine category nodes that have a logical link to a particular first attribute node in the first attribute list and a logical link to a particular second attribute node in the second attribute list;
f) creating a logical link linking the first selected wine and the wine category nodes in the wine category list.

17. The method of claim 16 wherein the food database model is a hierarchical model, and wherein a logical link to a particular food node is an implicit link to ancestor nodes of the particular food node.

18. The method of claim 16, wherein the first attribute is a region of original, and wherein the second attribute is a varietal.

19. The method of claim 16, wherein the steps of creating the first attribute list, the second attribute list, and the wine category list includes a substep of removing duplicates from the list.

20. A method of finding a set of all wine vintages in a list that are compatible with a given food type, comprising:
a) selecting a wine vintage from the list, said list stored in a database;
b) determining whether the wine vintage is compatible with the food type;
i) selecting a nonempty set of wine vintage features, including one or more features from the group consisting producer, region, varietal, quality rating, price category, and qualities with which to characterize particular wines;
ii) implementing in a computer software program a supervised statistical learner to associate each combination of values of the selected features observed in a collection of wine vintages with a set of foods for which the combination of values for the selected features is considered gastronomically compatible by experts;
iii) applying the supervised statistical learner to the combination of values for the selected features possessed by the given wine vintage; and
iv) determining whether the supervised statistical learner indicates that the given wine vintage is compatible with the given food type.
c) repeating steps a) and b) for the remainder of wine vintages in the list.

21. A method for preventing empty search results in a computerized database system comprising:
a) linking items in inventory to a plurality of characteristics, at least two of the characteristics being stored in an hierarchical data structure having parents of the characteristics being fully relevant to the linked item in inventory;
b) creating a computerized database table on a computer system, the database table having as columns each of the characteristics;
c) for each item in inventory,
i) selecting each characteristic in turn an creating a list of all linked characteristics and all parents of those characteristics;
ii) combine the Cartesian product of all lists created in substep i);
iii) adding the result to the database table;
d) removing duplicate rows from the database table; and
e) during a search by a user, using the database table to prune search options to those characteristics sets in inventory.
